(19) United States
(12) Patent Application Publication
(10) Pub. No.: US 2024/0354824 A1
(43) Pub. Date: Oct. 24, 2024

(54) Selecting an Attribute of an Item for DIsplay in an Interface Based on Information Gain Determined for the Attribute by a Trained Machine-Learned Model

(71) Applicant: Maplebear Inc. (dba Instacart), San Francisco, CA (US)

(72) Inventors: Viswa Mani Kiran Peddinti, San Francisco, CA (US); Claire Rossi-de Vries, San Francisco, CA (US); Matthew Timothy Izant, San Francisco, CA (US)

(21) Appl. No.: 18/138,002

(22) Filed: Apr. 21, 2023

(51) Int. Cl. G06Q 30/0601; G06N 3/084

(52) U.S. Cl. CPC G06Q 30/0625; G06N 3/084

(57) ABSTRACT

An online concierge system presents items to a user in one or more interfaces and maintains various attributes for each item. To optimize information about items in an interface, when the online concierge system receives a request for an interface, the online concierge system determines a context for the interface and a set of items to display in the interface from the request. For an item displayed by the interface, the online concierge system applies a trained attribute selection to each combination of the item, an attribute of the item, and the context for the interface to determine an information gain to the user from displaying the attribute of the item along with the item in the interface with the context. Based on the information gains, the online concierge system selects an attribute to display in the interface in conjunction with the item.

### BACKGROUND

Online concierge systems receive orders for items from users and provide the orders to a picker (or a shopper) for fulfillment. To fulfill an order, the online concierge system allocates the order to the picker, who obtains items in an order from a retailer. The picker delivers the obtained items to a user to fulfill the order. Because a user selects items from a retailer, the online concierge system displays one or more interfaces to a user identifying items available by the retailer to fulfill orders, with the user selecting items for inclusion in an order from one or more of the interfaces.

Additionally, an online concierge system maintains various attributes for each item offered by a retailer. An attribute of an item includes information describing the item. Example attributes of an item include organic, packaged, low-fat, vegan, or other descriptive information about the item. When the online concierge system displays items to a user through an interface, an attribute may be displayed in conjunction with each item. Displaying the attribute in conjunction with an item allows a user to ascertain information about the item from the interface to evaluate whether to include the item in an order from the interface.

However, an interface displayed by the online concierge system to users has limited display area for presentation of items and attributes of the items. This limits a number of attributes of an item that may be displayed in conjunction with the item by the interface, which reduces information about items available to the user via the interface. Additionally, displaying multiple attributes of an item in the interface may present a user with excessive information about items, impairing the user's navigation through the interface or review of different items. Further, the online concierge system displays interfaces having contexts (e.g., search results, a recipe, a carousel of items in a category, etc.), and different attributes of an item may provide different levels of information about the item to a user in different contexts in which the interface is displayed. Thus, displaying a specific attribute for an item across interfaces in different contexts provides a user with differing amounts of information about the item. While heuristically selecting an attribute of an item to display in different contexts allows for context-specific selection of an attribute of an item for display, heuristic selection is difficult to scale for increasing numbers of items or attributes, limiting ability of an online concierge system to maximize information about items displayed by interfaces having different contexts.

### SUMMARY

In accordance with one or more aspects of the disclosure, an online concierge system maintains items offered by various retailers and associates various attributes with each item. An attribute of an item provides descriptive information about the item, providing information about the item to users of the online concierge system. Additionally, the online concierge system displays one or more interfaces to users, with an interface displaying one or more items the online concierge system retrieved in response to a request for the interface from a user.

To provide additional information about an item displayed by an interface, the online concierge system displays one or more attributes of the item in conjunction with the item in the interface. As the interface has a limited display area for different items, displaying a large number of attributes in conjunction with an item makes the interface more cumbersome and difficult to navigate for users, and may provide excessive information about an item to a user that complicates the user's review of displayed items. To optimize information about an item in a display area of an interface for the item, the online concierge system selects an attribute, or a subset of attributes, for an item by evaluating information gain to a user provided by displaying different attributes of the item.

To select an attribute of an item to display in an interface, the online concierge system determines a context for display of the interface based on a received request for the interface from a user. For example, the context identifies the interface as search results, as a listing of items in a category, as a carousel display of items in a category, as a recipe, or as another format for display of items. The online concierge system determines the context from data included in the request, which may include metadata received with the request and/or data about the user.

Additionally, from the request to display the interface, the online concierge system retrieves a set of items satisfying the request. For example, the set of items are items having one or more attributes that at least partially match a search query in the request. As another example, the set of items are items in a category identified by the request or offered by a retailer identified by the request. In another example, the set of items are items included in a recipe identified by the request. Various attributes are associated with each item of the set by the online concierge system.

To account for a limited display area of the interface for displaying attributes of items, the interface displays a specific number of attributes in conjunction with each item. For example, the interface displays a single attribute in conjunction with each item. As different attributes of an item provide different levels of information about the item to users viewing the interface, in the particular context, to optimize an amount of information about items presented to users by the interface, the online concierge system trains an attribute selection model to determine an information gain for a combination of an item, an attribute of an item, and a context for the interface. Accounting for the context in which the interface is to be displayed when determining information gain from displaying different attributes of an item allows the online concierge system to account for different amounts of information an attribute provides in interfaces displayed in different contexts.

In various embodiments, the online concierge system trains the attribute selection model using training examples obtained by displaying randomly selected attributes in conjunction with a corresponding item in interfaces displayed to users of a subset and storing information describing display of the one or more interfaces. Stored information describing display of an interface includes a combination of an item that was displayed, an attribute of the item that was displayed, a context in which the interface was displayed, and an indication whether a user performed a specific action after display of the interface. Example specific actions include including an item in an order, saving an item, requesting additional information about an item, or another action involving an item. Based on numbers of times users of the subset perform the specific interaction after display of one or more interfaces in a context that includes an attribute displayed in conjunction with an item and numbers of times users of the subset perform the action after display of one or more interfaces in the context that includes a different attribute displayed in conjunction with the item, the online concierge system determines a context entropy of information for displaying the item in one or more interfaces having the context and an attribute entropy of information displaying the attribute of the item in conjunction with item in one or more interfaces having the context. The online concierge system determines an information gain for the combination of the item, the attribute of the item, and the context in a training example and applies the information gain as a value to the training example. Using the valued training example, the online concierge system trains the attribute selection model through backpropagation.

For each item of the set retrieved based on the request for the interface, the online concierge system determines a group of each combination of the item, an attribute of the item, and the determined context. The online concierge system applies the trained attribute selection model to each combination of the group, generating an information gain for each combination of the item, an attribute of the item, and the determined context. Based on the determined information gains, the online concierge system selects, for the item, an attribute of the item. The selected attribute is included for display in conjunction with the item in the interface having the determined context.

After selecting an attribute for each item of the set based on information gains for different combinations of item, attribute of the item, and determined context, the online concierge system generates the interface for display to the user. For each item of the set, the interface displays the item in conjunction with the attribute selected for the item from the determined information gains. Hence, the interface displays a selected attribute in conjunction with each item. The interface may display a single attribute in conjunction with each item, or may display a specific number of attributes in conjunction with each item. This allows the online concierge system to select one or more attributes of each item displayed in the interface that maximizes an amount of information about an item provided by the attribute displayed in conjunction with the item in the interface with the determined context. In some embodiments, the interface displays text describing a selected attribute in conjunction with a corresponding item, while in other embodiments the interface displays an image (e.g., an icon) or other representation of the selected attribute in conjunction with the corresponding item.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is a flowchart of a method for selecting an attribute of an item for display in an interface presented to a user of an online concierge system, in accordance with one or more embodiments.

FIG. 4 is a flowchart of a method for obtaining training examples for a training dataset for an attribute selection model from items and attributes displayed to users, in accordance with one or more embodiments.

FIG. 5 is a process flow diagram of a method for selecting an attribute of an item for display in an interface presented to a user of an online concierge system, in accordance with one or more embodiments.

### DETAILED DESCRIPTION

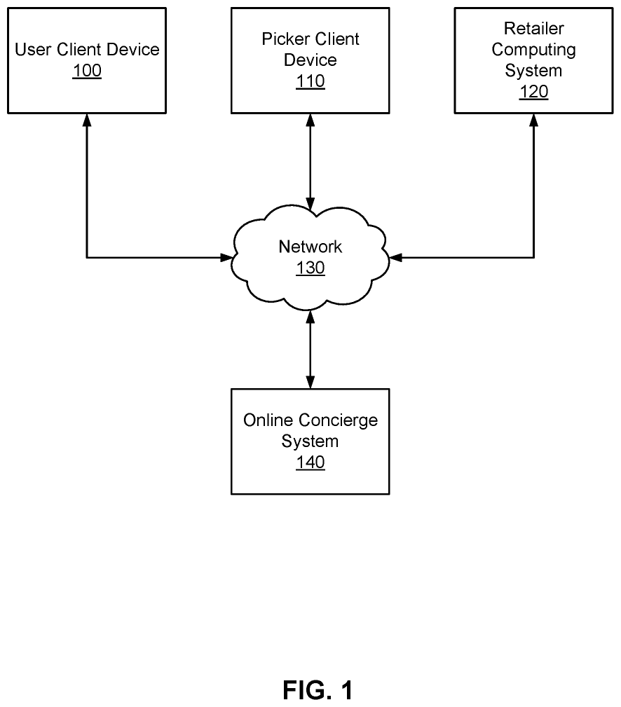

FIG. 1 illustrates an example system environment for an online concierge system 140, in accordance with one or more embodiments. The system environment illustrated in FIG. 1 includes a user client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, users, pickers, and retailers may be generically referred to as “users” of the online concierge system 140. Additionally, while one user client device 100, picker client device 110, and retailer computing system 120 are illustrated in FIG. 1, any number of users, pickers, and retailers may interact with the online concierge system 140. As such, there may be more than one user client device 100, picker client device 110, or retailer computing system 120.

The user client device 100 is a client device through which a user may interact with the picker client device 110, the retailer computing system 120, or the online concierge system 140. The user client device 100 can be a personal or mobile computing device, such as a smartphone, a tablet, a laptop computer, or desktop computer. In some embodiments, the user client device 100 executes a client application that uses an application programming interface (API) to communicate with the online concierge system 140.

A user uses the user client device 100 to place an order with the online concierge system 140. An order specifies a set of items to be delivered to the user. An “item,” as used herein, means a good or product that can be provided to the user through the online concierge system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The user client device 100 presents an ordering interface to the user. The ordering interface is a user interface that the user can use to place an order with the online concierge system 140. The ordering interface may be part of a client application operating on the user client device 100. The ordering interface allows the user to search for items that are available through the online concierge system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the item should be collected.

The user client device 100 may receive additional content from the online concierge system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online concierge system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same retailer location. The collection interface further presents instructions that the user may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the user client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a user's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the user client device 100 for display to the user such that the user can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a user from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The user client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which users can order items to be provided to them by a picker from a retailer. The online concierge system 140 receives orders from a user client device 100 through the network 130. The online concierge system 140 selects a picker to service the user's order and transmits the order to a picker client device 110 associated with the picker. The picker collects the ordered items from a retailer location and delivers the ordered items to the user. The online concierge system 140 may charge a user for the order and provides portions of the payment from the user to the picker and the retailer.

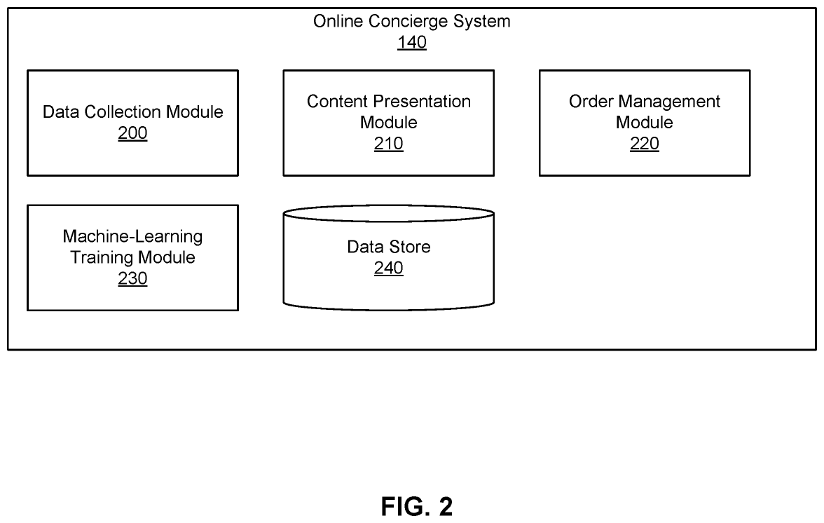

As an example, the online concierge system 140 may allow a user to order groceries from a grocery store retailer. The user's order may specify which groceries they want delivered from the grocery store and the quantities of each of the groceries. The user's client device 100 transmits the user's order to the online concierge system 140 and the online concierge system 140 selects a picker to travel to the grocery store retailer location to collect the groceries ordered by the user. Once the picker has collected the groceries ordered by the user, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default retailer/retailer location, payment instrument, delivery location, or delivery timeframe. The data collection module 200 may collect the user data from sensors on the user client device 100 or based on the user's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has services orders for the online concierge system 140, a user rating for the picker, which retailers the picker has collected items at, or the picker's previous shopping history. Additionally, the picker data may include preferences expressed by the picker, such as their preferred retailers to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a user associated with the order, a retailer location from which the user wants the ordered items collected, or a timeframe within which the user wants the order delivered. Order data may further include information describing how the order was serviced, such as which picker serviced the order, when the order was delivered, or a rating that the user gave the delivery of the order.

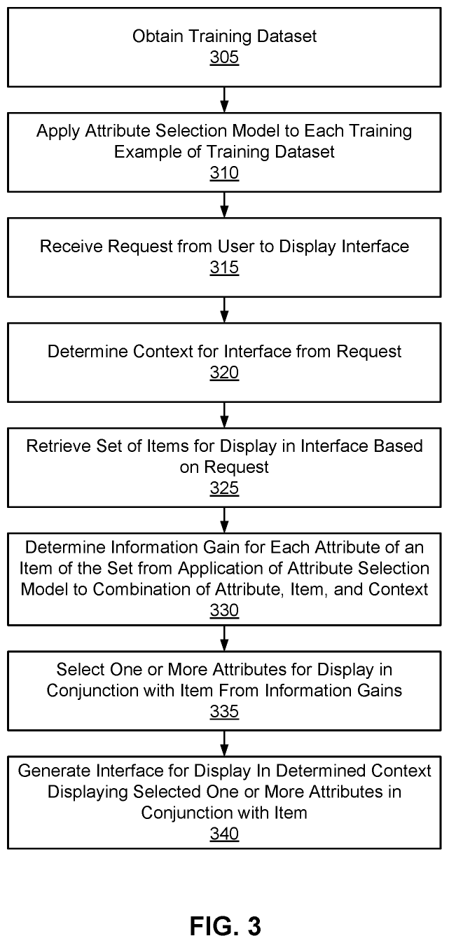

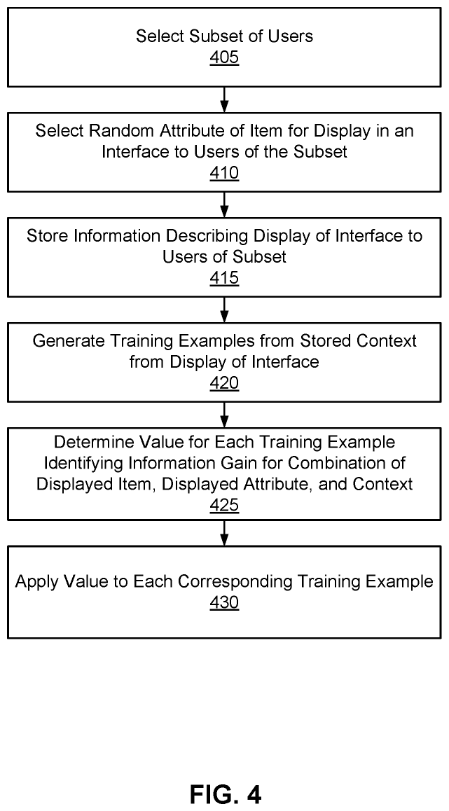

In various embodiments, the data collection module 200 captures and stores information describing display of various interfaces to users, capturing data describing interactions by users with interfaces or in response to display of interfaces. As further described below in conjunction with FIG. 4, the data collection module 200 captures information describing display of one or more interfaces to users in a subset identified by the data collection module 200. For example, when an interface is displayed to a user of the subset, the data collection module 200 stores a context in which the interface is displayed, one or more items displayed by the interface, one or more attributes of items displayed in conjunction with corresponding items, and an indication whether a user performed a specific action after being presented with the interface. The context identifies a format of the interface, which is related to a reason the user requested display of the interface, as further described below in conjunction with FIGS. 3 and 4. Examples of specific actions performed by the user include adding an item to an order, saving an item, requesting additional information about an item, or another action involving one or more items.

The content presentation module 210 selects content for presentation to a user. For example, the content presentation module 210 selects which items to present to a user while the user is placing an order. The content presentation module 210 generates and transmits the ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 generates one or more interfaces that display content to a user. For example, an interface displays various items to a user, while another information displays a single item and attributes of the item. The content presentation module 210 receives a request for an interface from a user client device 100 and generates an interface in response to the request. When generating the interface, the content presentation module 210 determines a context for the interface from the request. The context describes a format in which content is to be displayed in the interface, and is determined from data in the request for the interface. Example contexts for an interface include search results, a listing of items having an attribute (e.g., in a category, offered by a retailer) specified by the request, a recipe identified by the request, or other format for display of items.

To improve interaction by a user with a generated interface, the content presentation module 210 applies an attribute selection model to retrieved items for display in an interface, as further described below in conjunction with FIGS. 3-5. Based on the attribute selection model, the content selection module 210 selects one or more attributes to display in conjunction with an item in an interface. The attribute selection model receives a combination of an item, an attribute of the item, and a context for an interface as inputs and outputs an information gain to a user from displaying the attribute in conjunction with the item via the interface in the context. Thus, the information gain provides an indication of an amount of information about the item that the attribute provides when displayed with the item in an interface having the context. For each item to be displayed in an interface, the content selection module 210 applies the attribute selection model to each combination of the item, an attribute of the item, and a context for an interface, generating an information gain score for each of the combinations. From the information gains, the content presentation module 210 selects a combination and selects an attribute from the selected combination, as further described below in conjunction with FIGS. 3-5. The content presentation module 210 displays the selected attribute in conjunction with the corresponding item, allowing the content presentation module 210 to generate the interface so an attribute providing a maximum amount of information about an item is displayed in conjunction with each item. This allows the content presentation module 210 to generate an interface providing a maximum amount of information about displayed items while accounting for constraints on display areas within the interface for different items.

The content presentation module 210 may use an item selection model to score items for presentation to a user. An item selection model is a machine learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine learning models and may be stored in the data store 240.

In some embodiments, the content presentation module 210 scores items based on a search query received from the user client device 100. A search query is text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a user based on whether the predicted availability of the item exceeds a threshold.

The order management module 220 that manages orders for items from users. The order management module 220 receives orders from a user client device 100 and assigns the orders to pickers for service based on picker data. For example, the order management module 220 assigns an order to a picker based on the picker's location and the location of the retailer location from which the ordered items are to be collected. The order management module 220 may also assign an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to assign an order to a picker based on a delivery timeframe requested by the user with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the user with the location of the picker so that the user can track the progress of their order. In some embodiments, the order management module 220 computes an estimated time of arrival for the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the retailer.

The machine learning training module 230 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include user data, picker data, item data, or order data. In some cases, the training examples also include a value which represents an expected output of the machine learning model. In these cases, the machine learning model is trained by comparing its output from input data of a training example to the value for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a value, the loss function is also based on the value for the training example. Some example loss functions include the mean square error function, the mean absolute error, hinge loss function, and the cross-entropy loss function. The machine learning training module 230 updates the set of parameters for the machine learning model based on the score generated by the loss function. For example, the machine learning training module 230 may apply gradient descent to update the set of parameters.

As further described below in conjunction with FIGS. 3 and 4, the machine-learning training module 230 trains an attribute selection model that determines an information gain for a combination of an item, an attribute of the item, and a context for display of an interface including the item and the attribute of the item. The machine-learning training module 230 obtains a training dataset from the data collection module 200 from display of interfaces including items and attributes to users of a subset in different contexts. The training dataset includes multiple training examples that each include a combination of an item, an attribute of the item, and a context in which an interface including the item and the attribute were displayed to a user. From indications of the specific action performed by users in response to display of interfaces, the machine-learning training module 230 generates a value for a training example including a combination of an item, an attribute of the item, and a context in which an interface including the item and the attribute were displayed to a user, as further described below in conjunction with FIG. 4. The generated value is an information gain to a user from displaying the attribute of the combination in conjunction with the item of the combination in an interface displayed in the context identified by the combination. As further described above, and below in conjunction with FIGS. 3 and 4, the machine-learning training module 230 trains the attribute selection module to generate an information gain for a combination of an item, an attribute of the item, and a context in which an interface is displayed.

The data store 240 stores data used by the online concierge system 140. For example, the data store 240 stores user data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

FIG. 3 is a flowchart of a method for selecting an attribute of an item for display in an interface presented to a user of an online concierge system 140, in accordance with some embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system without human intervention.

As further described above in conjunction with FIG. 2, the online concierge system 140 maintains item data for items offered by a retailer or a retail location. The item data includes an item identifier of an item and one or more attributes of the item. Example attributes of an item include size, color, weight, packaging, nutritional information, ingredients of the item, dietary constraints satisfied by the item, or other information describing the item. Different attributes may be maintained for different items. Additionally, the online concierge system 140 displays one or more interfaces to a user that include one or more items. However, an interface displayed by the online concierge system 140 has limited display area for items, limiting a number of attributes of the items that may be displayed to provide information about an item without impairing a user's navigation of the interface.

To select an attribute of an item for display in an interface, the online concierge system 140 obtains 305 a training dataset including multiple training examples generated from display of different attributes of items to users in conjunction with the items and interactions performed by users in response to an interface displaying a combination of an attribute and a corresponding item. FIG. 4 is a flowchart of a method for obtaining 305 training examples for the training dataset for an attribute selection model from items and corresponding attributes displayed to users. In various embodiments, the online concierge system 140 performs the steps described in conjunction with FIG. 4 in different orders than the order shown in FIG. 4. Further, different or additional steps may be included in the method in some embodiments.

The online concierge system 140 selects 405 a subset of users. For example, the online concierge system 140 selects 405 a random subset of users. When displaying an interface including one or more items to a user of the subset, the online concierge system 140 selects 410 a random attribute of each item in the interface for display in the interface. In various embodiments, the online concierge system 140 selects a single attribute of each item in an interface to display in the interface to the user of the subset. Each time an interface including one or more items is displayed to a user of the subset, the online concierge system 140 randomly selects 410 an attribute of an item to be displayed in the interface. This allows the online concierge system 140 to display different attributes of items in different interfaces displayed to users of the subset. Such selection of different attributes for an item to display in various interfaces allows the online concierge system 140 to vary an attribute to a user of the subset by different interfaces.

As display of different interfaces correspond to different contexts, when an interface is displayed to a user of the subset, the online concierge system 140 stores 415 information describing display of the interface. The stored information includes a context in which the interface was displayed to the user of the subset, as well as pairs of items and corresponding attributes displayed to the user by the interface. A context, or a “display context,” of the interface describes a format in which the interface displays items, which may be specified by reason or a situation causing display of the interface. For example, a context is search results based on the online concierge system 140 receiving a search query. As another example, a context identifies a listing of items in a category selected by a user. In another example, a context specifies display of a recipe to a user. The context may specify how items are displayed in the interface, such as in a carousel, in a list, or in another format. Thus, for each interface displayed to a user of the subset, the online concierge system 140 stores 415 a context for display of the interface and pairs of items and a corresponding attribute displayed by the interface.

In various embodiments, the online concierge system 140 also stores 415 an indication of a specific action performed by the user of the subset with one or more items displayed by the interface. The online concierge system 140 stores the indication in response to the user performing the specific action and does not store the indication in response to the user not performing the specific interaction in some embodiments. Alternatively, the online concierge system 140 stores a first value for the indication in response to the user performing the specific action and stores a different second value for the indication in response to the user not performing the specific interaction. For example, a specific action is inclusion of an item displayed by the interface in an order by the user of the subset. As another example, a specific action is a request to save an item displayed by the interface for subsequent review. In some embodiments, the online concierge system 140 stores 415 an identifier of a specific action performed by a user of the subset in association with the context for display of the interface and pairs of items and a corresponding attribute displayed by the interface. The online concierge system 140 may identify different specific interactions by the user in different embodiments. Varying the attribute associated with an item displayed by an interface to users of the subset allows the online concierge system 140 to evaluate effects of different attributes on performance of the specific action by users of the subset.

From the stored information describing presentation of interfaces to users of the subset, the online concierge system 140 generates 420 training examples for a training dataset for an attribute selection model. Each training example includes a combination of an item, an attribute of the item displayed in an interface, and a context for display of the interface. This allows a training example to account for an item and an attribute of the item that was displayed, as well as a context in which the interface including the item and the corresponding attribute was displayed.

For each training example including an item, an attribute of the item, and a context for display of an interface, the online concierge system 140 determines 425 a value for the training example. The value is an information gain to a user from displaying the attribute for the item when the interface is displayed in the context. The information gain from displaying an attribute provides a measure of the value provided to a user from displaying the attribute in conjunction with the item in an interface with context relative to other attributes of the item. Hence, the information gain of an attribute provides an indication of how displaying the attribute in conjunction with an item affects a likelihood of a user performing one or more specific interactions with the item via the interface.

To generate 425 a value for a training example, the online concierge system 140 determines a context entropy of a context of an interface in the training example. The context entropy provides a measure of an average amount of information provided to a user by display of the item in an interface having the context of the training example. To determine the context entropy for training example, the online concierge system 140 retrieves stored information from display of one or more interfaces to users of the subset that include the combination of the item and the context of the training example and determines a number of times an interface included the item of the training example and was displayed in the context of the training example. Additionally, the online concierge system 140 determines a number of times one or more users performed the specific action in response to display of the item of the training example in an interface of the training example. The online concierge system 140 determines a ratio of the number of times the specific interaction was performed in response to display of the item of the training example via an interface in the context of the training example to the number of times the item of the training example was included in an interface presented in the context of the training example. Based on the determined ratio, the online concierge system 140 determines the context entropy. In various embodiments, the online concierge system 140 determines the context entropy using the following equation:

$$Entropy = - 1 ( x * {log}_{2} ( x ) + ( 1 - x ) * {log}_{2} ( 1 - x ) ) \qquad ( 1 )$$

In equation (1), the determined ratio as the value for “x” in various embodiments.

When generating 425 the value for the training example for which the context entropy was determined, the online concierge system 140 also determines an attribute entropy of an attribute of the training example displayed in conjunction with the item of the training example in the context of the training example. The attribute entropy of the training example provides a measure of an average amount of information provided to a user by display of the attribute of the training example along with the item of the training example in an interface having the context of the training example. To determine the attribute entropy for the training example, the online concierge system 140 retrieves stored information from display of one or more interfaces to users of the subset in the context of the training example that include the item of the training example and a number of times an interface displaying the attribute of the training example in conjunction with the item of the training example was displayed in the context of the training example. Additionally, the online concierge system 140 determines a number of times the specific action was performed by one or more users in response to display of the attribute of the training example in conjunction with the item of the training example in an interface displayed in the context of the training example. The online concierge system 140 determines an attribute display ratio for the training example as a ratio of the number of times the specific action was performed in response to display of the attribute of the training example in conjunction with the item of the training example in one or more interfaces displayed in the context of the training example to the number of times one or more interfaces displayed in the context of the training example and including the attribute of the training example displayed in conjunction with the item of the training example were displayed. The online concierge system 140 determines an attribute display entropy for the combination of the item, the attribute, and the context of the training example from the attribute display ratio. For example, the online concierge system 140 applies equation (1) above to the attribute display ratio, with the attribute display ratio being the value of “x” in equation (1), to determine the attribute display entropy of the training example.

Additionally, to determine the attribute entropy for the training example, the online concierge system 140 determines an attribute withheld entropy for the combination of the item, the attribute, and the context of the training example. To determine the attribute withheld entropy, the online concierge system 140 determines a number of times an interface was displayed in the context of the training example and displayed the item of the training example in conjunction with an alternative attribute of the item that is different from the item of the training example. Additionally, the online concierge system 140 determines a number of times one or more users performed the specific action in response to display of the item of the training example and an alternative attribute of the item of the training example in the context of the training example. The online concierge system 140 determines an attribute withheld ratio for the training example as a ratio of the number of times the specific action was performed in response to display of an alternative attribute of the item of the training example in conjunction with the item of the training example in one or more interfaces displayed in the context of the training example to the number of times one or more interfaces were displayed in the context of the training example and displayed an alternative attribute of the item of the training example in conjunction with the item of the training example. The online concierge system 140 determines an attribute withheld entropy based on the attribute withheld ratio. For example, the online concierge system 140 applies equation (1) above to the attribute withheld ratio, with the attribute withheld ratio used as the value of “x” in equation 1, to determine the attribute withheld entropy for the combination of the item, the attribute, and the context of the training example.

From the attribute display entropy and the attribute withheld entropy, the online concierge system 140 determines the attribute entropy for a training example. The online concierge system determines a product of the attribute display entropy for the training example and a ratio of a number of times one or more interfaces displaying the attribute of the training example in conjunction with the item of the training example were displayed to one or more users of the subset in the context of the training example to a number of times one or more interfaces displaying the item of the training example were displayed to one or more users of the subset in the context of the training example. Additionally, the online concierge system 140 determines an additional product of the attribute withheld entropy for the training example and a ratio of a number of times one or more interfaces displaying an alternative attribute of the item of the training example in conjunction with the item of the item of the training example were displayed to one or more users of the subset in the context of the training example to a number of times one or more interfaces displaying the item of the training example were displayed to one or more users of the subset in the context of the training example. In various embodiments, the online concierge system 140 determines the attribute entropy of the training example by summing the product and the additional product. In the preceding example, the ratios allow determination of the attribute entropy of the training example to account for a frequency with which the attribute of the training example was displayed in conjunction with the item of the training example in the context of the training example and an additional frequency with which a different or alternative attribute of the item of the training example was displayed in conjunction with the item of the training example in the context of the training example.

From the context entropy and the attribute entropy for the training example, the online concierge system 140 determines the information gain for the combination of the attribute, the item, and the context of the training example. In various embodiments, the information gain is a difference between the context entropy of the training example and the attribute entropy of the training example. As further described above, the context entropy of the training example and the attribute entropy of the training example are based on a rate at which users perform a specific action after display of one or more interfaces including the item of the training example in the context of the training example, so the change in performance of the specific action by users provides a proxy for an amount of additional information about the item of the training example provided to users from display of the attribute of the training example in the context of the training example, allowing the value determined 425 for a training example to leverage interactions by users in response to different content presented in one or more interfaces to determine an amount of information about an item obtained from display of the attribute in conjunction with the item in an interface displayed in the context. This allows the online concierge system 140 to base information gain for the training example on changes in a number of times, or in a frequency with which, users perform the specific action when the attribute of the training example is displayed in conjunction with the item of the training example relative to when the attribute of the training example is not displayed in conjunction with the item of the training example.

For the training example including a combination of the item, the attribute, and the context in which one or more interfaces were displayed to users of the subset, the online concierge system 140 applies 430 a value including the determined information gain. Hence, the value applied 430 applied to a training example represents an information gain to users from displaying the attribute of the training example in conjunction with the item of the training example through an interface displayed in the context of the training example. The online concierge system 140 determines 425 an information gain for each of a plurality of training examples from the stored information and applies 430 a value of the determined information gain to each of the plurality of training examples. In various embodiments, the online concierge system 140 determines 425 an information gain for all attributes of an item displayed in an interface having a context and applies 430 a corresponding value to training examples for each combination of the item, an attribute of the item, and the context. Additionally, the online concierge system 140 generates 420 a training example for each item of a set of items, with training examples for an item each including a combination of the item, an attribute of the item, and a context of an interface in which the item and the attribute were displayed, as further described above, and determines 425 an information gain for each combination of the item, an attribute of the item, and context. A value corresponding to a determined information gain is applied 430 to each training example. This allows the online concierge system 140 to leverage user interactions from display of attributes in conjunction with items in different contexts of interfaces to generate 420 training examples for the attribute selection model and to determine 425 the values applied 430 to the training examples.

Referring back to FIG. 3, after obtaining 305 the training dataset, the online concierge system 140 trains the attribute selection model by applying 310 the attribute selection model to each training example of the training dataset. The attribute selection model predicts an information gain for an attribute displayed in conjunction with a representation of an item (e.g., item features) through an interface with attributes associated with a context (such as training using features of search queries so there is more generalizability for queries not seen before). So, the attribute selection model receives a combination of an item, an attribute of the item, and a context for an interface and outputs an information gain corresponding to display of the attribute in conjunction with the item via an interface displayed in the context. The attribute selection model comprises a set of weights stored on a non-transitory computer readable storage medium in various embodiments. For training, the online concierge system 140 initializes a network of a plurality of layers comprising the attribute selection model, with each layer including one or more weights. As described above, the attribute selection model receives a combination of an item, an attribute of the item, and a context for display of an interface as an input and generates a predicted information score for displaying the attribute in conjunction with the item in an interface displayed in the context. The weights comprise a set of parameters used by the attribute selection model to transform the input data—the item, the attribute of the item, and the context for display of an interface—received by the attribute selection model into output data—the information gain from display of the attribute in conjunction with the item via an interface displayed in the context.

The online concierge system 140 generates the parameters (e.g., the weights) for the attribute selection model through training by applying 310 the attribute selection model to training examples generated from display of different combinations of items and corresponding attributes through interfaces displayed in one or more contexts, as further described above in conjunction with FIG. 4. After initializing the set of weights comprising the attribute selection model, the online concierge system 140 applies 310 the attribute selection model to multiple training examples of the training dataset. As further described above in conjunction with FIG. 4, each training example includes a combination of an item, an attribute of the item, and a display context in which an interface was displayed, with a value applied to a training example indicating an information gain to users from displaying the attribute in conjunction with the item in an interface displayed with the context. Hence, the value provides a measure of information about the item provided by displaying the attribute of the item along with the item via an interface in the context. As further described above in conjunction with FIG. 4, the value for application to a training example is determined from performance of a specific action by users after display of an attribute in conjunction with an item through an interface having a context. Applying 310 the attribute selection model to a training example generates a predicted information gain for displaying the attribute of the item of the training example in conjunction with the item of the training example via an interface displayed in the display context of the training example.

For each training example of the training dataset to which the attribute selection model is applied 310, the online concierge system 140 generates an error term based on a predicted information gain for the training example output by the attribute selection model and the value applied to the training example. The error term is larger when a difference between the predicted information gain and the value applied to the training example is larger and is smaller when the difference between the predicted information gain and the value applied to the training example is smaller. In various embodiments, the online concierge system 140 generates the error term between the predicted information gain output by the attribute selection model and the value applied to the training example using a loss function. Example loss functions include a mean square error function, a mean absolute error, a hinge loss function, and a cross-entropy loss function.

The online concierge system 140 backpropagates the error term to update the set of parameters comprising the attribute selection model and stops backpropagation in response to the error term, or the loss function, satisfying one or more criteria. For example, the online concierge system 140 backpropagates the error term through the attribute selection model to update parameters of the attribute selection model until the error term has less than a threshold value. For example, the online system 140 may apply gradient descent to update the set of parameters. The online concierge system 140 stores the set of parameters comprising the attribute selection model on a non-transitory computer readable storage medium after stopping the backpropagation.

After storing the trained attribute selection model, the online concierge system 140 receives 315 a request from a user to display an interface. From the request, the online concierge system 140 determines 320 a context for the interface. For example, the request to display an interface is a search query, and the online concierge system 140 determines 320 a context of search results for the interface. As another example, the request from the user is a selection of a category of items, and the determined context for the interface is a list of items or a carousel display of items. As another example, the request from the user is a request to display a recipe, so the online concierge system 140 determines 320 a recipe is the context for the interface. In some embodiments, the online concierge system 140 determines 320 the context for the interface from information included in the request, such as a type of device on which the interface is to be presented or other information. The determined context for the interface may include features from the request, such as a search query, a category identifier, a retailer identifier, a recipe identifier, or other descriptive information from the request.

Based on the request, the online concierge system 140 retrieves 325 a set of items for display in the requested interface. If the request is a search query, the online concierge system 140 retrieves 325 a set of items each having at least one attribute at least partially matching the search query. If the request identifies a recipe, the online concierge system 140 retrieves 325 a set of items included in the identified recipe. If the request identifies a category, the retrieved set of items are items in the identified category. If the request includes other information, the online concierge system 140 retrieves 325 a set of items that each have at least one attribute matching (or partially matching) the information included in the request.

For each item of the retrieved set, the online concierge system 140 determines 330 an information gain for displaying each attribute of an item in conjunction with the item through an interface having the determined context by applying the attribute selection model to a combination of an item of the set, an attribute of the item of the set, and the determined context. In various embodiments, the online concierge system 140 identifies an item of the set and determines a group of combinations based on attributes of the identified item. Each combination of the group includes the identified item, an attribute of the identified item, and the determined context, with different combinations including different attributes of the identified item. The online concierge system 140 applies the attribute selection model to each combination of identified item, an attribute of the identified item, and the determined context in the group, determining 330 an information gain for each combination. The information gain determined 330 for a combination determines an information gain for displaying the attribute of identified item in the combination when displayed in conjunction with the identified item via an interface having the determined context. For an identified item of the set, the online concierge system 140 determines 330 an information gain for each attribute of the identified item when displayed in conjunction with the item in an interface having the determined context in parallel. For example, the online concierge system 140 applies the attribute selection model to each combination of a group determined for the identified item in parallel. Hence, the online concierge system 140 determines 330 an information gain for each combination of an item of the set, an attribute of the corresponding item of the set, and the determined context. For each item of the set, the online concierge system 140 determines 330 an information gain for each combination of the item, an attribute of the item, and the determined context.

For an item of the set, the online concierge system 140 selects 335 one or more attributes for display based on the determined information gains. In one or more embodiments, the online concierge system 140 identifies an item of the set and selects a combination of the identified item, an attribute of the identified item, and the determined context having a maximum information gain. The online concierge system 140 selects 335 the attribute included in the selected combination. Alternatively, the online concierge system 140 ranks combinations of the identified item, an attribute of the identified item, and the determined context, with combinations having higher information gains having higher positions in the ranking. The online concierge system 140 selects a combination having at least a threshold position in the ranking and selects 335 an attribute included in the selected combination. In some embodiments, the online concierge system 140 selects 335 an attribute of the item included in a combination having the highest position in the ranking. The online concierge system 140 selects 335 one or more attributes for each item of the set based on corresponding information gains, as further described above. In various embodiments, the selected 335 one or more attributes are a subset of attributes associated with the item, so the online concierge system 140 reduces a number of attributes associated with the item for display relative to the number of attributes maintained for the item.

The online concierge system 140 generates 340 the interface for display in the determined context, with the interface displaying a selected attribute of an item in conjunction with the item. The interface displays a specific number of attributes in association with each item, with the specific number of attributes common for each item displayed by the interface. In some embodiments, the interface displays one attribute in conjunction with each item. The selected attribute for an item may be displayed as text describing the selected attribute, as an image (e.g., an icon) describing the selected attribute, or in another format. However, in other embodiments, the interface displays a different specific number of attributes in association with each item. This allows the interface to display one or more attributes in conjunction for an item, with the one or more attributes selected for display in conjunction with an item based on information gains for combinations of the item, an attribute of the item, and the determined context for display of the interface. For example, the interface displays a single attribute in conjunction with each item, so the online concierge system 140 selects 335 a single attribute for each item to be displayed in the interface along with a corresponding item based on determined information gains, as further described above. By selecting 335 an attribute of an item displayed by the interface in conjunction with the item based on information gain from displaying the item and the attribute of the item in an interface having the context, the online concierge system 140 optimizes display area in the interface to maximize the amount of information about the item provided to by the interface. This allows the interface to optimize limited display area for information about items to a user, while simplifying navigation through the interface for the user.

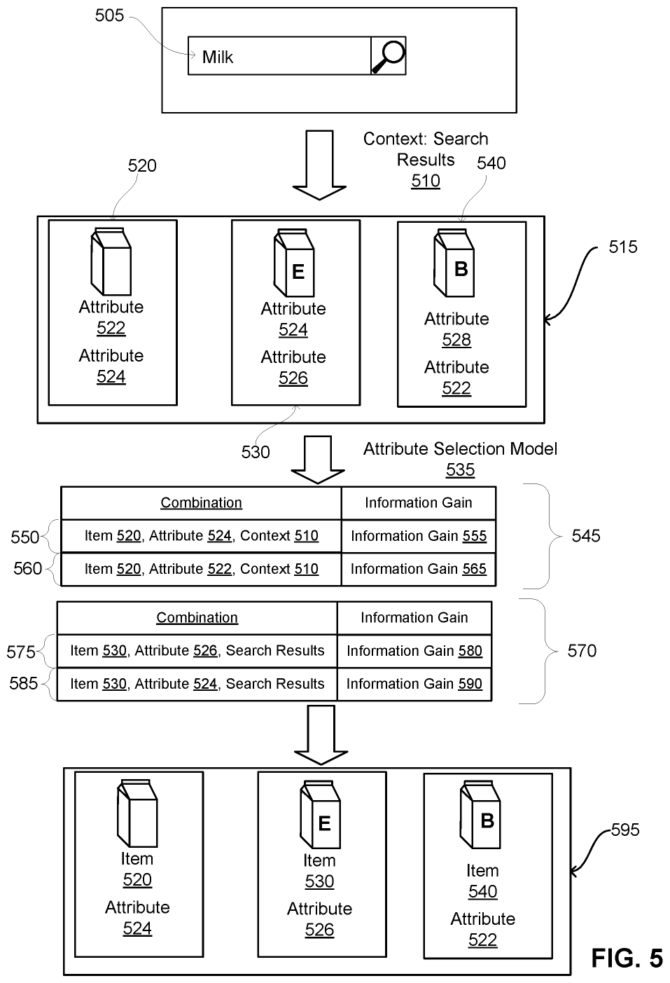

FIG. 5 is a process flow diagram of a method for selecting an attribute of an item for display in an interface presented to a user of an online concierge system 140. In the example of FIG. 5, the online concierge system 140 receives a search query 505 from a user. The search query 505 is a request for the online concierge system 140 to display an interface to the user, with the interface including search results based on the search query 505. As further described above in conjunction with FIG. 3, the online concierge system 140 determines a context 510 in which the interface is to be displayed based on the request. In the example of FIG. 5, the online concierge system 140 determines a context of search results based on the search query 505. Determining the context 510 from the request allows the online concierge system 140 to determine a format in which content (e.g., items) are displayed by an interface, which provides an indication of information about items (or other content) in the interface likely to be of interest to the user from whom the search query 505 was received. The online concierge system 140 determines the context 510 from data included in the request, which may include metadata received with the request.

In response to the request to display the interface, the online concierge system 140 retrieves a set 515 of items. Each item of the set 515 has one or more attributes that satisfy the request. In the example of FIG. 5, the online concierge system 140 retrieves items having one or more attributes that at least partially match the search query 505. For purposes of illustration, FIG. 5 shows the set 515 as including item 520, item 530, and item 540, each of which having an attribute partially matching the received search query 505. However, in other embodiments, the set 515 may include any number of items with attributes satisfying the request.

The online concierge system 140 maintains attributes associated with each item, with an attribute of an item providing information describing the item. In the example of FIG. 5, attribute 522 and attribute 524 are maintained by the online concierge system 140 for item 520, while attribute 524 and attribute 526 are maintained by the online concierge system 140 in association with item 530. Similarly, attribute 522 and attribute 528 are maintained in association with item 540. In various embodiments, the online concierge system 140 maintains different numbers of attributes in association with different items. Thus, each item of the set 515 is associated with one or more attributes by the online concierge system 140.

However, an interface generated by the online concierge system 140 in response to a request (e.g., the search query 505) has limited display area to display attributes of items of the set 515. For example, many computing devices, such as mobile devices, have limited display areas for displaying content. When displaying an interface on such a limited display area, inclusion of a large number of attributes about an item along with the item in an interface provides a user with excessive information. This increases an amount of time and complexity for a user to evaluate attributes of items, to select an item, or to navigate the interface. Further, withholding display of attributes of items in the interface prevents the user from obtaining information about an item from the interface, increasing an amount of interaction between the user and the online concierge system 140 to obtain information about items. For example, preventing display of attributes of items in the interface may cause the user to navigate through multiple interfaces to obtain information about items displayed by the interface.

To simplify interaction with the interface while providing information about various items through the interface, the interface displays a specific number of attributes in conjunction with each item. For example, the interface displays a single attribute in conjunction with each item. As different attributes of an item provide different levels of information about the item to users viewing the interface, the online concierge system 140 trains an attribute selection model 535, as further described above in conjunction with FIGS. 3 and 4, to optimize an amount of information about items presented by the interface. The attribute selection model 535 receives a combination of an item, an attribute of the item, and the context 510 in which the interface is presented. Based on the combination of the item, the attribute of the item, and the context 510, the attribute selection model 535 outputs an information gain to a user from displaying the attribute of the item in conjunction in the item through an interface displayed in the context 510. Accounting for the context 510 in which an interface is displayed allows the attribute selection module to account for different amounts of information about an item provided by an attribute when displayed in interfaces displayed in different contexts.

The online concierge system 140 applies the attribute selection model to each combination of an item of the set 515 and a corresponding attribute of the item of the set 515 for the context 510 in which the interface is displayed. In various embodiments, the online concierge system 140 identifies an item of the set 515 and generates a group that includes each combination of the identified item, an attribute of the identified item, and the context 510 for the interface. The online concierge system 140 applies the attribute selection model 535 to each combination generated for the identified item to evaluate the information gain provided to a user from displaying different attributes of the identified item in conjunction with the identified item via an interface in the context 510.

In the example of FIG. 5, the online concierge system 140 identifies item 520 and generates a group 545 including each combination of the item 520, an attribute of the item 520, and the context 510. In the example of FIG. 5, the group 545 includes combination 550 of item 520, attribute 524 of item 520, and context 510, as well as combination 560 of item 520, attribute 522 of item 520, and context 510. Hence, group 545 includes each combination of item 520 and an attribute of item 520. The online concierge system 140 applies the attribute selection model 535 to each combination of group 545, generating a corresponding information gain for each combination of group 545. In the example of FIG. 5, combination 550 has information gain 555, while combination 560 has information gain 565. Based on the information gain for each combination of group 545, the online concierge system 140 selects one or more attributes of item 520 for display. In the example of FIG. 5, the online concierge system 140 ranks combination 550 and combination 560 based on their corresponding information gains, with information gain 555 of combination 550 exceeding information gain 565 of combination 560 in FIG. 5. Based on the ranking, the online concierge system 140 selects attribute 524 from combination 550 for display in conjunction with item 520, as combination 550 has a maximum position in the ranking based on information gains.

Similarly, the online concierge system 140 identifies item 530 from the set 515 and generates group 570 including each combination of item 530, an attribute of the item 530, and the context 510. In the example of FIG. 5, group 570 includes combination 575 of item 530, attribute 526 of item 530, and context 510, as well as combination 585 of item 530, attribute 524 of item 530, and context 510. As further described above, the online concierge system 140 applies the attribute selection model 535 to each of combination 575 and combination 585, generating information gain 580 for combination 575 and information gain 590 for combination 585. In the example of FIG. 5, the online concierge system 140 ranks combination 575 and combination 585 based on information gain 580 and information gain 590, with information gain 580 exceeding information gain 590. Based on the ranking, the online concierge system 140 selects attribute 526 from combination 575 for display in conjunction with item 530, as combination 575 has a maximum position in the ranking based on information gains.

In various embodiments, the online concierge system 140 identifies each item of set 515 and generates a group for each identified item, with the group for an identified item including each combination of the identified item of set 515, an attribute maintained for the identified item of the set 515, and context 510. As further described above, the online concierge system 140 applies attribute selection model 535 to each combination in the group generated for an identified item to generate an information gain corresponding to each combination of the group for the identified item of the set 515, an attribute of the identified item of the set 515, and context 510. Based on the generated information gains, the online concierge system 140 ranks the combinations of the group and selects a combination having a maximum position, or a threshold position, in the ranking. The online concierge system 140 selects an attribute of the identified item of the set 515 included in the combination having the maximum position in the ranking, or the threshold position in the ranking, for display in the interface.

After selecting an attribute for each item of the set 515, the online concierge system 140 generates interface 595 for display to the user. In the example of FIG. 5, interface 595 displays search results identifying items based on search query 505. Interface 595 displays item 520 of set 515 in conjunction with attribute 524, which was selected for item 520 as further described above. Similarly, interface 595 displays item 530 in conjunction with attribute 526, which was selected for item 530 as further described above. Interface 595 also displays item 540 of set 515, with attribute 522 of item 540, which was selected by the online concierge system 140, as further described above, displayed in conjunction with item 540. While interface 595 displays a single attribute in conjunction with each item, in other embodiments, interface 595 displays a different specific number of attributes in conjunction with each item. In various embodiments, the specific number of attributes specifies a subset of attributes associated with items to limit how many attributes are displayed in conjunction with an item. This allows the online concierge system 140 to leverage the attribute selection model 535 to select an attribute of each item displayed in interface 595 that maximizes an amount of information about a corresponding item when displayed in conjunction with the item in interface 595 having contest 510. In some embodiments, interface 595 displays text describing a selected attribute in conjunction with a corresponding item, while in other embodiments interface 595 displays an image (e.g., an icon) or other representation of the selected attribute in conjunction with the corresponding item.

### ADDITIONAL CONSIDERATIONS

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and values associated with the training examples. The training process may include applying the machine learning model to a training example, comparing an output of the machine learning model to the value associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
receiving a request from a user device associated with a user to display an interface, the interface including one or more items;
determining a context in which the interface is to be displayed based on the request;
retrieving a set of items for display in the interface based on the request, each item of the set associated with one or more attributes;
for each item of the set:
determining a group including each combination of the item of the set, an attribute of the item of the set, and the determined context,
determining an information gain for each combination of the group by applying an attribute selection model to a combination, and
selecting an attribute for display in conjunction with the item based on the determined information gains;
generating the interface for display to the user, the interface displaying an item of the set and displaying the corresponding selected attribute for the item of the set in conjunction with the item of the set; and
causing the user device to display the generated interface.

2. The method of claim 1, wherein selecting the attribute for display in conjunction with the item based on the determined information gains comprises:
ranking the combinations of the group based on the information gain determined for each combination of the group; and
selecting the attribute included in a combination of the group having at least a threshold position in the ranking.

3. The method of claim 2, wherein the threshold position in the ranking is a highest position in the ranking.

4. The method of claim 1, wherein the attribute selection model is trained by:
obtaining a training dataset including a plurality of training examples, each training example including a combination of an item, an attribute of the item, and a display context in which one or more interfaces were displayed, and each training example having a value indicating an information gain from displaying the attribute of the item in conjunction with the item in an interface displayed in the display context;
applying the attribute selection model to each training example of the training dataset to generate a predicted information gain from displaying the attribute of the item of the training example in conjunction with the item of the training example in an interface displayed in the display context of the training example;
scoring the attribute selection model using a loss function and the value of the training example;
updating one or more parameters of the attribute selection model by backpropagation based on the scoring until one or more criteria are satisfied; and
storing the updated one or more parameters of the attribute selection model.

5. The method of claim 4, wherein the information gain from displaying the attribute of the item in conjunction with the item in the interface displayed in the display context is based on a difference between a context entropy of the display context for display of the item in the display context and an attribute entropy of the attribute displayed with the item in the interface with the display context.

6. The method of claim 4, wherein training examples of the training dataset are generated from interactions by information describing display of one or more interfaces to users of a subset including a context in which an interface was displayed, pairs of items and corresponding attributes displayed by the interface, and an indication of a specific action performed by a user of the subset after display of the interface.

7. The method of claim 1, wherein the context is one or more of: search results, a carousel display of items, a list of items, or a request to display a recipe.

8. The method of claim 1, wherein the interface displays text comprising the selected attribute for the item of the set in conjunction with the item of the set.

9. A method comprising:
obtaining a training dataset including a plurality of training examples, each training example including a combination of an item, an attribute of the item, and a context in which one or more interfaces were displayed, and each training example having a value indicating an information gain from displaying the attribute of the item in conjunction with the item in an interface displayed in the context;
applying an attribute selection model to each training example of the training dataset to generate a predicted information gain from displaying the attribute of the item of the training example in conjunction with the item of the training example in an interface displayed in the context of the training example;
scoring the attribute selection model using a loss function and the value of the training example;
updating one or more parameters of the attribute selection model by backpropagation based on the scoring until one or more criteria are satisfied; and
storing the updated one or more parameters of the attribute selection model.

10. The method of claim 9, wherein obtaining the training dataset including the plurality of training examples comprises:
selecting a subset of users of an online concierge system;
displaying a random attribute associated with each item in one or more interfaces displayed to users of the subset;
storing information describing display of one or more interfaces to users of the subset including a context in which an interface was displayed, pairs of items and corresponding attributes displayed by the interface, and an indication of a specific action performed by a user of the subset after display of the interface;
generating a training dataset of training examples from the stored information, each training example including a combination of an item displayed in the interface, an attribute of the item displayed by the interface, and a context in which the interface was displayed;
determining a value for each training example from stored information describing an information gain to a user from displaying the attribute included in the training example in conjunction with the item included in the training example in one or more interfaces having the context included in the training example;
applying the determined value to a corresponding training example;
applying an attribute selection model to each training example of the training dataset to generate a predicted information gain from displaying the attribute of the item of the training example in conjunction with the item of the training example in the interface displayed in the context of the training example;
scoring the attribute selection model using a loss function and the value of the training example;
updating one or more parameters of the attribute selection model by backpropagation based on the scoring until one or more criteria are satisfied; and
storing the updated one or more parameters of the attribute selection model.

11. The method of claim 10, wherein determining the value for each training example from stored information describing the information gain to the user from displaying the attribute included in the training example in conjunction with the item included in the training example in one or more interfaces having the context included in the training example comprises:
determining a context entropy for the combination of the item, the attribute, and the context included in the training example, the context entropy based on stored information describing display of one or more interfaces including the item included in the training example in the context included in the training example;
determining an attribute entropy for the combination of the item, the attribute, and the context included in the training example, the attribute entropy based on stored information describing display of one or more interfaces including the attribute included in the training example displayed in conjunction with the item included in the training example in the context included in the training example; and
determining the information gain for the training example as a difference between the context entropy and the attribute entropy.

12. The method of claim 11, wherein determining the context entropy for the combination of the item, the attribute, and the context included in the training example comprises:
determining a number of times one or more interfaces including the item included in the training example were displayed in the context included in the training example from the stored information;
determining a number of times one or more users performed the specific action in response to display of at least one interface including the item of the training example in the context included in the training example;
determining a ratio of the number of times one or more users performed the specific action in to display of at least one interface including the item of the training example in the context included in the training example to the number of times one or more users performed the specific action in response to display of at least one interface including the item of the training example in the context included in the training example; and
determining the context entropy based on the determined ratio.

13. The method of claim 12, wherein determining the attribute entropy for the combination of the item, the attribute, and the context included in the training example comprises:
determining a number of times one or more interfaces displayed the attribute included in the training example in conjunction with the item included in the training example in the context included in the training example from the stored information;
determining a number of times the specific action was performed by one or more users in response to display of the attribute included in the training example in conjunction with the item included in the training examples in one or more interfaces displayed in the context included in the training example;
determining an attribute display ratio of the number of times the specific action was performed by one or more users in response to display of the attribute included in the training example in conjunction with the item included in the training examples in one or more interfaces displayed in the context included in the training example to the number of times one or more interfaces displayed the attribute included in the training example in conjunction with the item included in the training example in the context included in the training example;
determining an attribute display entropy based on the attribute display ratio;
determining a number of times one or more interfaces displayed a different attribute than the attribute included in the training example in conjunction with the item included in the training example in the context included in the training example from the stored information;
determining a number of times the specific action was performed by one or more users in response to display of the different attribute included in the training example in conjunction with the item included in the training examples in one or more interfaces displayed in the context included in the training example;
determining an attribute withheld ratio of the number of times the specific action was performed by one or more users in response to display of the different attribute included in the training example in conjunction with the item included in the training examples in one or more interfaces displayed in the context included in the training example to the number of times one or more interfaces displayed the different attribute than the attribute included in the training example in conjunction with the item included in the training example in the context included in the training example;
determining an attribute withheld entropy based on the attribute withheld ratio; and
determining the attribute entropy based on the attribute display entropy and the attribute withheld entropy.

14. The method of claim 13, wherein determining the attribute entropy based on the attribute display entropy and the attribute withheld entropy comprises:
determining a product of the attribute display entropy and a ratio of a number of times one or more interfaces displaying the attribute included in the training example in conjunction with the item included in the training example was displayed to one or more users of the subset in the context included in the training example to a number of times one or more interfaces displaying the item was displayed to one or more users of the subset in the context included in the training example;
determining an additional product of the attribute withheld entropy and an additional ratio of a number of times one or more interfaces displaying the different than the attribute included in the training example in conjunction with the item included in the training example was displayed to one or more users of the subset in the context included in the training example to a number of times one or more interfaces displaying the item included in the training example was displayed to one or more users of the subset in the context included in the training example; and
determining the attribute entropy as a sum of the product and the additional product.

15. A computer program product comprising a non-transitory computer readable medium having instructions encoded thereon that, when executed by a processor, cause the processor to perform steps comprising:
receiving a request from a user device associated with a user to display an interface, the interface including one or more items;
determining a context in which the interface is to be displayed based on the request;
retrieving a set of items for display in the interface based on the request, each item of the set associated with one or more attributes;
for each item of the set:
determining a group including each combination of the item of the set, an attribute of the item of the set, and the determined context,
determining an information gain for each combination of the group by applying an attribute selection model to a combination, and
selecting an attribute for display in conjunction with the item based on the determined information gains;
generating the interface for display to the user, the interface displaying an item of the set and displaying the corresponding selected attribute for the item of the set in conjunction with the item of the set; and
causing the user device to display the generated interface.

16. The computer program product of claim 15, wherein selecting the attribute for display in conjunction with the item based on the determined information gains comprises:
ranking the combinations of the group based on the information gain determined for each combination of the group; and
selecting an attribute included in a combination of the group having at least a threshold position in the ranking.

17. The computer program product of claim 15, wherein the attribute selection model is trained by:
obtaining a training dataset including a plurality of training examples, each training example including a combination of an item, an attribute of the item, and a display context in which one or more interfaces were displayed, and each training example having a value indicating an information gain from displaying the attribute of the item in conjunction with the item in an interface displayed in the display context;
applying the attribute selection model to each training example of the training dataset to generate a predicted information gain from displaying the attribute of the item of the training example in conjunction with the item of the training example in an interface displayed in the display context of the training example;
scoring the attribute selection model using a loss function and the value of the training example;
updating one or more parameters of the attribute selection model by backpropagation based on the scoring until one or more criteria are satisfied; and
storing the updated one or more parameters of the attribute selection model.

18. The computer program product of claim 17, wherein the information gain from displaying the attribute of the item in conjunction with the item in the interface displayed in the display context is based on a difference between a context entropy of the display context for display of the item in the display context and an attribute entropy of the attribute displayed with the item in the interface with the display context.

19. The computer program product of claim 17, wherein training examples of the training dataset are generated from interactions by information describing display of one or more interfaces to users of a subset including a context in which an interface was displayed, pairs of items and corresponding attributes displayed by the interface, and an indication of a specific action performed by a user of the subset after display of the interface.

20. A system comprising:
one or more processors; and
the computer program product of claim 15.
